(19) United States
(12) Patent Application Publication
(10) Pub. No.: US 2025/0108279 A1
(43) Pub. Date: Apr. 3, 2025

(54) METHODS AND SYSTEMS OF GAMEPLAY

(71) Applicant: WORLD WIDE FLAG FLAP BALL, LLC, Deming, NM (US)

(72) Inventor: Edward S. Baca, Deming, NM (US)

(73) Assignee: WORLD WIDE FLAG FLAP BALL, LLC, Deming, NM (US)

(21) Appl. No.: 18/905,095

(22) Filed: Oct. 2, 2024

Related U.S. Application Data
(60) Provisional application No. 63/541,919, filed on Oct. 2, 2023.

(51) Int. Cl. A63B 67/00; A63B 43/00; A63B 71/06

(52) U.S. Cl. CPC A63B 67/002; A63B 43/002; A63B 71/0616; A63B 71/0669; A63B 2209/10

(57) ABSTRACT

A weighted ball includes an exterior including a top layer and a bottom layer joined together at least at a perimeter of the layers. A weighted insert is disposed in a center portion of the ball, between the top and bottom layer, and a plurality of flexible wings extends radially from the center portion of the ball. Each wing is configured to lie in a shared plane with the center portion. Each wing can deflect above or below said shared plane. A flag harness includes a belt portion configured to be wrapped around a player; an upper strap extending from a front section to a rear section; and a flag portion attached to the belt portion or upper strap. The flag portion is an elongated flexible fabric strap having an inner end attached to the belt portion or upper strap and an opposite outer end or tail.

This application claims priority to co-pending U.S. Provisional Application No. 63/541,919 filed Oct. 2, 2023, which is incorporated herein by reference in its entirety.

### TECHNICAL FIELD

The present disclosure generally relates to recreational games, as well as methods for playing and officiating.

### TECHNICAL BACKGROUND

Current recreational games are too competitive. A need exists for fun and safe ways to get exercise, fellowship, and meet people.

### SUMMARY

An embodiment of the present disclosure takes the form of a gameplay system including a weighted ball and a flag harness. The weighted ball includes an exterior surrounding the weighted ball, wherein the exterior includes a top layer and a bottom layer joined together at least at a perimeter of the layers. The system further includes a weighted insert disposed in a center portion of the ball, between the top and bottom layer, and a plurality of flexible wings extending radially from the center portion of the ball, wherein each wing is configured to lie in a shared plane with the center portion in an undeflected state, and wherein each wing deflects above or below said shared plane in a deflected state when subjected to external forces. The flag harness includes a belt portion configured to be wrapped around a player in a horizontal direction; an upper strap extending from a front section to a rear section of the belt portion, configured to cross a chest, shoulder, and back of the player; and a flag portion attached to the belt portion or upper strap, wherein the flag portion is an elongated flexible fabric strap having an inner end attached to the belt portion or upper strap and an opposite outer end or tail, wherein the inner end is sewn to the belt portion at a junction with the upper strap.

Another embodiment of the present disclosure takes the form of a method of gameplay using a weighted ball and flag harnesses including passing a weighted ball between team members of a team in possession of the ball while avoiding flag pulling by one or more opposing teams, wearing a flag harness, wherein the flag harness includes a flag portion attached to a player's back, wherein the flag portion is configured to be pulled by opponents, utilizing a website platform for joining teams, creating teams, scheduling games, and tracking game statistics.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a perspective view of an example weighted ball, according to one or more embodiments described and illustrated herein;

FIG. 2 depicts a top view of the example weighted ball of FIG. 1, according to one or more embodiments shown and described herein;

FIG. 3 depicts a first side view of the example weighted ball of FIGS. 1-2, according to one or more embodiments shown and described herein;

FIG. 4 depicts a second side view of the example weighted ball of FIGS. 1-3, according to one or more embodiments shown and described herein;

FIG. 5 depicts a third side view of the example weighted ball of FIGS. 1-4, according to one or more embodiments shown and described herein;

FIG. 6 depicts a fourth side view of the example weighted ball of FIGS. 1-5, according to one or more embodiments shown and described herein;

FIG. 7 depicts a bottom view of the example weighted ball of FIGS. 1-6, the top view of the weighted ball being identical thereto according to one or more embodiments shown and described herein;

FIG. 8 depicts a front perspective view of an example flag, according to one or more embodiments shown and described herein;

FIG. 9 depicts a back perspective view of the example flag of FIG. 8, according to one or more embodiments shown and described herein;

FIG. 10 depicts an unattached back perspective view of the example flag of FIGS. 8-9, according to one or more embodiments shown and described herein; and

FIG. 11 depicts a flowchart of a method in accordance with the present invention.

### DETAILED DESCRIPTION

The present disclosure generally describes methods and systems of gameplay for a game that includes a unique system balls and flags. Players of the game form teams and pass a weighted ball to fellow members. Players of an opposing team try to pull a flag of the player holding the weighted ball.

### Weighted Ball

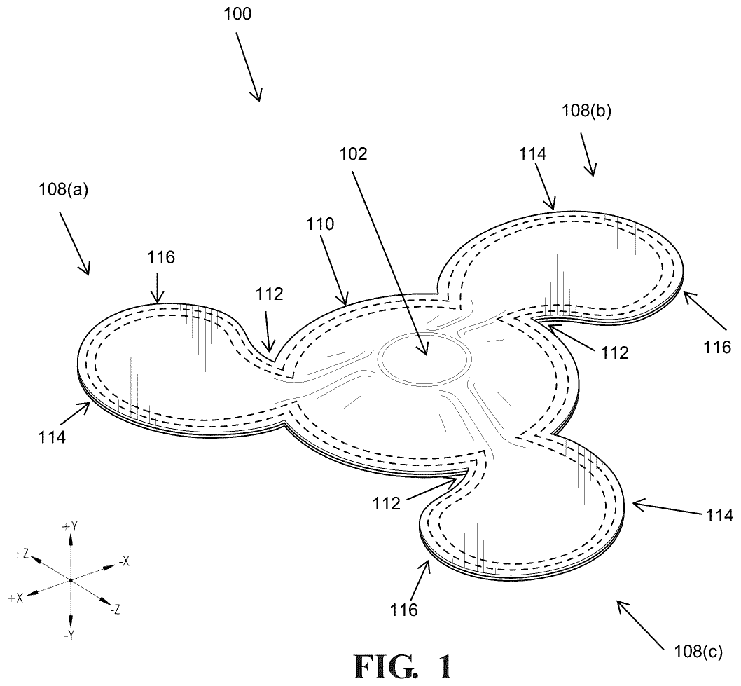

Referring to FIG. 1, a weighted ball 100 is shown. The weighted ball 100, e.g., a top layer 104 and a bottom layer 106, of the weighted ball 100, can be constructed of cloth like material, such as leather. The top layer 104 and the bottom layer 106 are stitched together to form an exterior of the weighted ball 100. A weighted insert (internal of the weighted ball 100 and not shown) is disposed in the weighted ball 100, e.g., at a center 102 of the weighted ball 100. The weighted insert may include a material of higher density than the top layer 104 and the bottom layer 106. For example, the weighted insert may include a solid material, such as a metal slug, and/or a granulated material, such as sand, powdered metal or the like disposed in a pouch. The weighted insert may have various sizes and weights.

The weighted ball 100 also has wings 108, such as wings 108(a), 108(b), and 108(c) that extend generally radially outward from the center 102. The wings 108 allow easy gripping. The wings 108 may be flexible, e.g., from and undeflected state shown in the FIGS to a deflected state (not shown). In the undeflected state, the wings 108(a), 108(b), and 108(c) may each lie generally in the same plane as the center 102. When deflected, e.g., along a vertical Y-axis, the wings 108(a), 108(b), and 108(c) may extend above and/or below the plane. While three wings 108 are depicted, the weighted ball 100 may have any number of wings 108. Each wing 108 is configured to bend by elastic deformation towards the center 102.

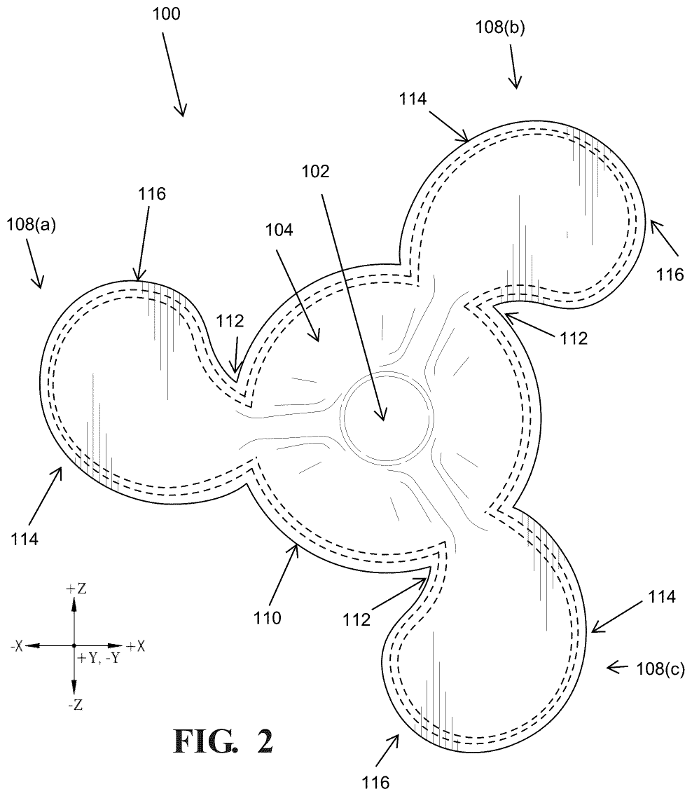

The weighted ball includes an insert at the center 102. The center 102 has a circular perimeter 110 and the wings 108(a), 108(b), and 108(c) attach to this perimeter 110, the wings 108(a), 108(b), and 108(c) are narrower at the connection to the center 108 and widen away from the center 102 in a curved shape as shown in FIGS. 1 and 2. The top layer 104 and bottom layer 106 close at the perimeter 110 of the weighted ball 100 such that the thickest part of the weighted ball 100 is at the center 102, and the weighted ball 100 becomes more narrow than at center 102, approaching the perimeter 110.

FIG. 2 depicts a top view of the example weighted ball 100 of FIG. 1. The wings 108 are shaped aerodynamically such that a perimeter of the wings 108(a), 108(b), and 108(c) curve in a clockwise or counterclockwise direction, e.g., circumferentially relative to the Y-axis. Each wing 108 curves outwardly starting at one end and is indented, i.e., includes an indent 112, on an opposite side closest to the center. This may be described as being a propeller-shaped configuration. For example, each wing 108(a), 108(b), and 108(c) may have a first side 114 and an opposite second side 116. The first side 114 and the second side 116 may extend generally radially outward from the perimeter 110 of the center 102 and meet at a distal end of the respective wing 108(a), 108(b), and 108(c). The first side 114 and the second side 116 may define an outer edge of the respect wing 108(a), 108(b), and 108(c). The first side 114 may curves outwardly from one end of the respective wing 108(a), 108(b), and 108(c), e.g., away from the second side 116. The second side 116 may be indented opposite the first side 114 of the respective wing 108(a), 108(b), and 108(c), e.g., toward the first side 114. Each wing 108(a), 108(b), and 108(c) may be generally smooth and continuous along the first side 114 and the second side 116, i.e., free from breaks, sharp corners or cusps.

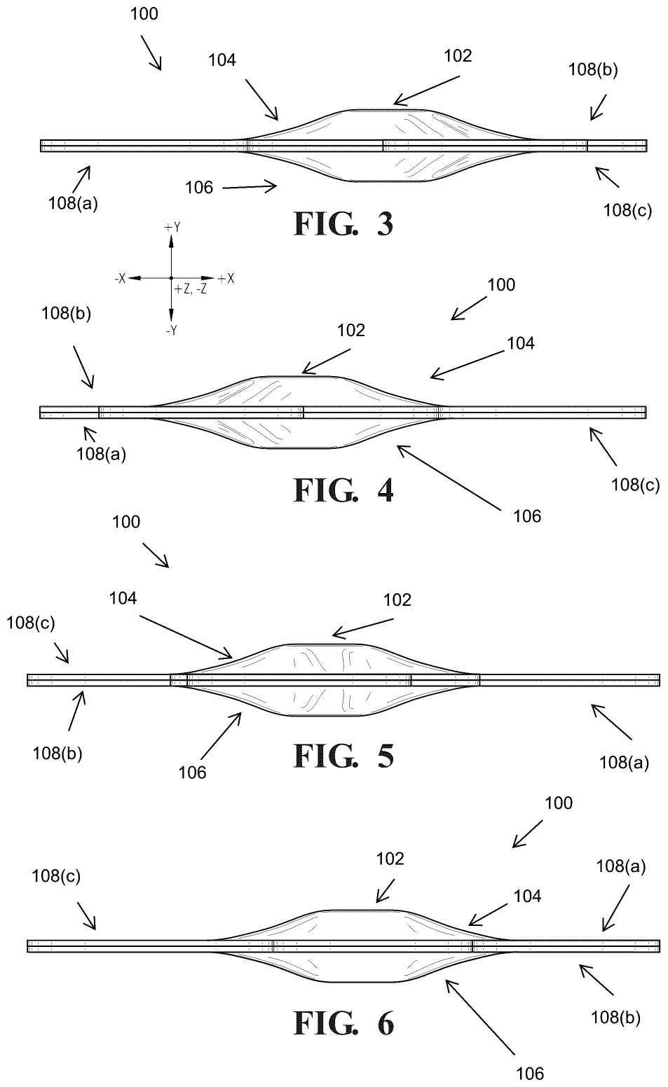

FIGS. 3-6 depict side views of the example weighted ball 100 of FIGS. 1-2. The figures depict how the weighted ball 100 may rotate about the Y-axis. The weighted ball 100 rotates from a first position in FIG. 3 to a second, third, and fourth position as shown in FIGS. 4-6 respectively. The weighted ball 100 moves upon an external being applied toward a point of interest and the weighted ball 100 rotates about the Y-axis upon force being applied in the X-axis and/or Z-axis direction. The weighted insert and the wings 108(a), 108(b), and 108(c) may control kinematics of the weighted ball 100 to encourage rotation about the Y-axis, e.g., by providing an increased weight to a center of mass of the weighted ball 100 and stabilization to rotate within the X-Z plane due to circumferential forces of the wings 108(a), 108(b), and 108(c).

Also as shown in FIGS. 3-6 the weighted ball 100 may be thicker along the Y-axis at the center 102 than at the wings 108. The top layer 104 and bottom layer 106 close at the perimeter 110 of the weighted ball 100 such that the thickest part of the weighted ball 100 is at the center 102, and the weighted ball 100 becomes progressively thinner from center to the perimeter 110. The wings 108(a), 108(b), and 108(c) have generally consistent thickness from center to the perimeter. For example, the wings 108(a), 108(b), and 108(c) may lay flat for gripping and aerodynamic purposes.

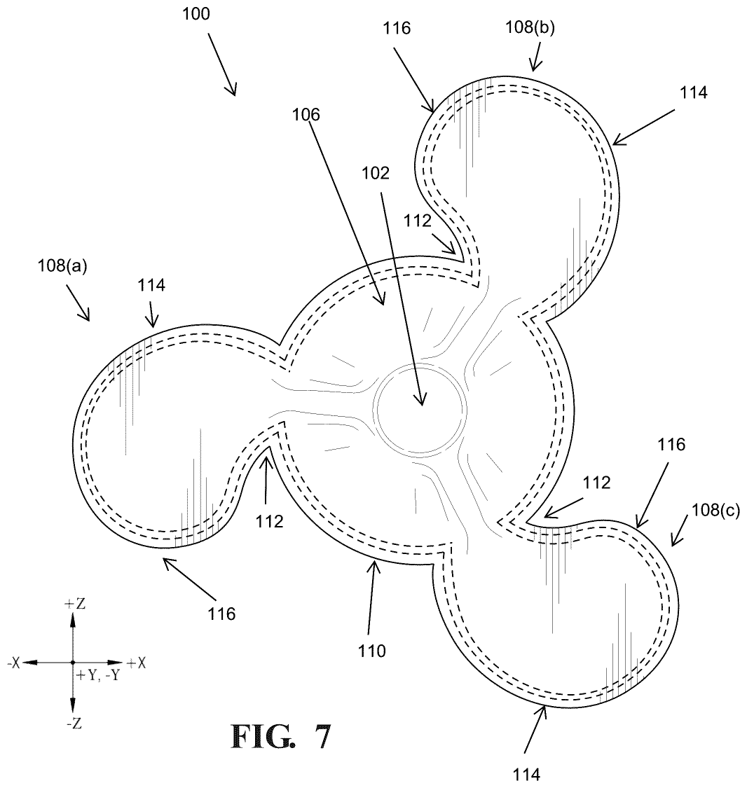

FIG. 7 depicts a bottom view of the example weighted ball 100 of FIGS. 1-6. The bottom view and the top view of the weighted ball 100 are identical.

The size of the weighted ball 100 can be small, medium or large to accommodate players of different skill levels. A smaller or bigger weighted ball 100 can be used for less or more advanced levels of play.

### Flags

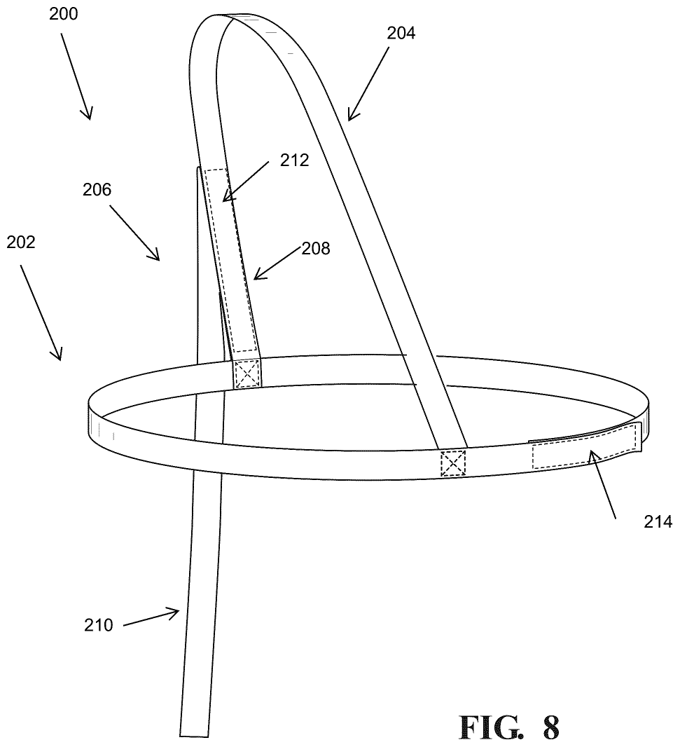

With reference to FIGS. 8-10, team players wear flag harnesses 200 during gameplay. FIG. 8 depicts a front perspective view of an example flag harness 200. The flag harness 200 has a belt portion 202 which wraps generally horizontally around the waist or chest area of a player. The belt portion 202 may be adjustable in size and secured as a full loop via a mechanism such as a hook and loop portion 214.

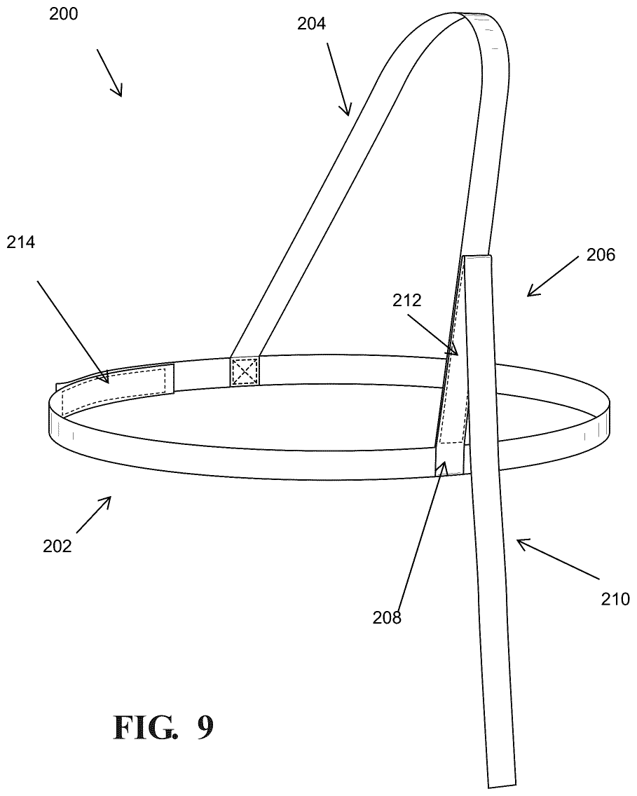

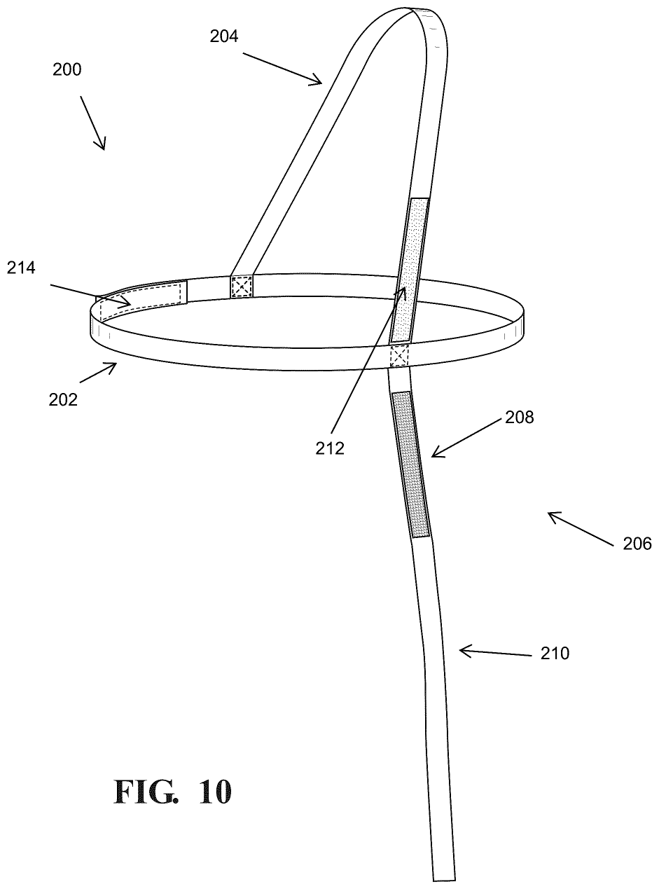

An upper strap 204 of the flag harness 200 extends from a front section to a rear section of the belt portion 202 and, in use, crosses the chest, shoulder and back of a player. The flag harness 200 also has a flag portion 206. The flag portion 206 may be an elongated flexible fabric strap having an inner end 208 that is attached to the belt portion 202 or upper strap 204 of the flag harness 200 and an opposite outer end or tail 210. In the illustrated example, the inner end 208 is sewn to the belt portion 202 where the upper strap 204 joins the belt portion 202. This area may be on the rear of the flag harness 200 when in use. The flag portion 206 may also have one or more strip(s) 212 made of hook and loop fastener material and corresponding strip(s) 212 of hook and loop fastener material may be fixed to a rear section of the upper strap 204. The flag portion 206 is movable from an attached state, shown in FIGS. 8 and 9, to an unattached state shown in FIG. 10. The flag portion 206 may be moved from the attached state to the unattached state by apply force to, e.g., by a player pulling on, the flag portion 206. The flag portion 206 may be moved from the unattached state to the attached state by pressing the strip(s) 212 of hook and loop fastener material together.

FIG. 9 depicts a back perspective view of the example flag of FIG. 8 in the attached state. The corresponding strip(s) 212 of hook and loop fastener on the flag portion 206 and upper strap may be joined as shown. Team players have the flag placed on their backs for minimal physical contact.

FIG. 10 depicts a back perspective view of the example flag portion 206 of FIGS. 8-9 in the unattached stated. When the tail 210 of the flag portion 206 is pulled, the hook and loop fastener material disconnects but the inner end 208 of the flag portion 206 stays intact.

### Gameplay

Gameplay utilizes the weighted ball 100 and flag harnesses 200 as described above. Official weighted balls 100 and flag harnesses 200 can be displayed and purchased from a website (e.g., shopflagflapball.com). Gameplay can occur in any suitable location, such as an open field, park, backyard, or football field. Games can utilize any field sizes or boundaries. Teams can determine boundaries based on location.

In embodiments, players are split into two equal teams.

A website (e.g., flagflapball.com) account can be used to join or create a team. The website can also be used to find another team to play against.

Teams can be any size. For example each team can have two or more players. Each team may have a team leader and team stopwatch. A team leader can search and find a local team using an integrated map locator and request a team to play. The team leader can schedule games by date and location and record team data to update a team profile at the end of each game.

Games can be played in any suitable time intervals. For example, games can be played in four, fifteen minute quarters for a total of 60 minutes. All teams can start wearing flag harnesses 200. A first team of players can start with the weighted ball 100. Players of the first team can pass the weighted ball 100 between team-members, avoiding another team from pulling their flag portions 206 when holding the weighted ball 100. The weighted ball 100 can be passed in any manner (throwing, tossing, flinging, etc.)

Players try to keep the weighted ball 100 within their team for the most minutes during the game. The winner will have the most tracked minutes at the end. In embodiments, team leaders can keep a score of the game by using a stopwatch that tracks the minutes and seconds the weighted ball 100 is held for their team. In alternative embodiments, the game is scored by pulled flag portions 206 and the team with the most pulled flag portions 206 wins.

In embodiments, when a flag portion 206 is pulled from the player's back holding the weighted ball 100, the player immediately drops the weighted ball 100 and leaves the field, unable to participate in the remainder of the game.

Once a flag portion 206 is pulled from the player's back holding the weighted ball 100, the other team will pick up the weighted ball 100 and will be given a head start before the first team can pursue the players' flag portions 206. For example, a team leader from the second team can count down a three second head start that starts when the second team possesses the weighted ball 100. The possession can alternate accordingly until the game is over.

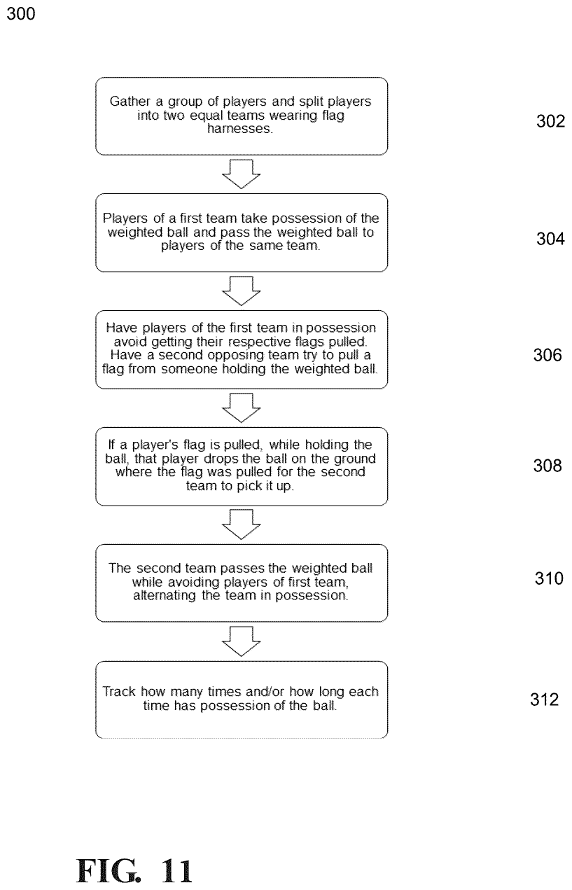

FIG. 11 illustrates exemplary method 300 of playing the game. At step 302 a group of players is gathered and split into equal teams wearing flag harness. At step 304 the players of a first team take possession of the weighted ball and pass the ball to players of the same team. At step 306 players of the first team in possession try to avoid getting their respective flags pulled. Players of a second opposing team try pull a flag from someone holding the weighted ball. At step 308, if a player's flag is pulled while holding the ball, the player drops the weighted ball on the ground where the flag was pulled for the second team to pick it up. At step 310 the second team passes the weighted ball while avoiding players of first team, alternating the team in possession. At step 312 how many times or how long each time has possession of the ball is tracked for scorekeeping.

If the weighted ball 100 is dropped without a flag portion 206 being pulled, the team of possession can pick it up and continue the game.

In embodiments, active players of the game can be substituted with other inactive members of the same team.

Players can be speed tested for proper team placement. Alternatively teams can decide to have players of any speed. Teams can be matched according to recorded speed levels. A speed testing performed with a timed 40-yard dash. The dash can be started before 40 yards such that a player is at peak speed for the duration of the dash. Dash times can be recorded using a website reporting system.

It will be understood by those of skill in the art that various alternatives of the above-described aspects and embodiments may be used without departing from the scope of the claims.

It should now be understood that embodiments described herein provide for gameplay and systems and methods thereof.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A gameplay system comprising:
a weighted ball, the weighted ball comprising:
an exterior surrounding the weighted ball, wherein the exterior comprises a top layer and a bottom layer joined together at least at a perimeter of the layers;
a weighted insert disposed in a center portion of the ball, between the top and bottom layer; and
a plurality of flexible wings extending radially from the center portion of the ball, wherein each wing is configured to lie in a shared plane with the center portion in an undeflected state, and wherein each wing deflects above or below the shared plane in a deflected state when subjected to external forces; and a flag harness, the flag harness comprising:
a belt portion configured to be wrapped around a player in a horizontal direction;
an upper strap extending from a front section to a rear section of the belt portion, configured to cross a chest, shoulder, and back of the player; and
a flag portion attached to the belt portion or upper strap, wherein the flag portion is an elongated flexible fabric strap having an inner end attached to the belt portion or upper strap and an opposite outer end or tail, wherein the inner end is sewn to the belt portion at a junction with the upper strap.

2. The gameplay system of claim 1, wherein a number of the wings is in a range from one to five.

3. The gameplay system of claim 1, wherein each wing has a first side that curves outwardly from one end of a respective wing and a second side that is indented opposite the first side of the respective wing.

4. The gameplay system of claim 1, wherein the weighted ball is designed to rotate about a vertical axis when an external force is applied to the weighted ball.

5. The gameplay system of claim 1, wherein the flexible wings are constructed from a material that allows for bending and deformation.

6. The game play system of claim 1, wherein the flag portion further comprises a strip made of hook and loop fastener material, and a corresponding strip of hook and loop fastener material is fixed to a rear section of the upper strap.

7. The gameplay system of claim 1, wherein the flag portion is positioned on a back of the flag harness.

8. The gameplay system of claim 1, wherein the flag portion is designed to detach from the belt portion or upper strap upon a pulling force.

9. The gameplay system of claim 1, further comprising an adjustment mechanism on the belt portion.

10. A method of gameplay using a weighted ball and flag harnesses, comprising:
passing a weighted ball between team members of a team in possession of the ball while avoiding flag pulling by one or more opposing teams;
wearing a flag harness, wherein the flag harness includes a flag portion attached to a player's back, wherein the flag portion is configured to be pulled by opponents;
utilizing a website platform for joining teams, creating teams, scheduling games, and tracking game statistics.

11. The method of claim 10, wherein teams consist of two or more players and are led by a designated team leader responsible for coordinating game logistics.

12. The method of claim 10, wherein gameplay occurs in various locations, including open fields, parks, backyards, or football fields, with boundaries determined by the a location.

13. The method of claim 10, wherein the game is played in time intervals of four quarters of fifteen minutes each, and a winner is determined based on a total minutes the ball is held by the team.

14. The method of claim 10, wherein a team leader tracks a game score using a stopwatch that records a total time the ball is held by the teams.

15. The method of claim 10, wherein upon the flag portion being pulled from a player, the player immediately drops the ball and leave for a remainder of the game.

16. The gameplay system of claim 10, wherein after the flag portion is pulled, the opposing team receives a predetermined amount of time with the ball before the opposing team can pursue the ball.

17. The method of claim 10, wherein if the ball is dropped without the flag portion being pulled, the team in possession may pick it up and continue gameplay.

18. The method of claim 10, wherein players of the team in possession of the ball or the one or more opposing teams can be substituted during the gameplay with inactive players of the respective team in possession of the ball or the one or more opposing team.

19. The method of claim 10, wherein players undergo speed testing for proper team placement, with results recorded on the website platform, and wherein teams may be matched according to recorded speed levels.
